(19) United States
(12) Patent Application Publication
(10) Pub. No.: US 2005/0252926 A1
(43) Pub. Date: Nov. 17, 2005

(54) Packaged goods delivering device

(76) Inventor: Junichi Atsuta, Chiba (JP)

Correspondence Address: STAAS & HALSEY LLP, SUITE 700, 1201 NEW YORK AVENUE, N.W., WASHINGTON, DC, 20005, US

(21) Appl. No.: 10/517,654

(22) PCT Filed: Jun. 30, 2003
(86) PCT No.: PCT/JP03/08290

§ 371 Date: Dec. 13, 2004

(30) Foreign Application Priority Data
Jul. 1, 2002 (JP) 2002-192066

(51) Int. Cl. A47F 1/04; G07F 11/00

(52) U.S. Cl. 221/155

(57) ABSTRACT

A packaged commodity dispensing device in which a package commodity dispensing machine is easily repaired and a packaged commodity is easily supplied and exchanged. The packaged commodity dispensing machine dispenses a packaged commodity; a frame into which the packaged commodity dispensing machine is permitted to detachably fit from forward; and a fixing section to fix the packaged commodity dispensing machine in a state of fitting into the frame.

### FIELD OF THE INVENTION

The present invention relates to a packaged commodity dispensing device for a dispensing packaged commodity.

In the specification, a “packaged commodity” is wide-ranging concept that includes not only a capsule commodity but also a commodity encapsulated in a container such as a box or the like and a commodity wrapped in paper.

### BACKGROUND ART

Earlier, for example, as a capsule commodity dispensing machine for dispensing a capsule commodity, one in which a rotation drum inside is rotated by turning a handle after inserting a coin, and a capsule commodity on the rotation drum is dispensed from a commodity dispense opening through a hole in the rotation drum and an opening under the rotation drum has been known. Such a capsule commodity dispensing machine is generally set up at a toy section or a landing of a department store, a game center, the inside of or outside the front of a convenient store, an amusement park or the like.

In this case, the capsule commodity dispensing machines are piled in two or three stages. When piling them, the capsule commodity dispensing machine is fixed just above the lower capsule commodity dispensing machine.

However, when piling the capsule commodity dispensing machines in multiple stages in the upper and lower direction, there is a problem of impairing the stability depending on the shape of the capsule commodity dispensing machine. On the other hand, when not piling the capsule commodity dispensing machines in multiple stages, there is a problem of decreasing space efficiency for setting up the capsule commodity dispensing machines.

Also, even when piling the capsule commodity dispensing machines in multiple stages, in the case of removing and repairing the capsule commodity dispensing machines in the middle excluding the capsule commodity dispensing machines in the highest and lowest stages, or replacing the capsule commodity dispensing machines in the middle, the work may become cumbersome. Further, the work to supply the capsule commodities into the capsule commodity dispensing machine or collecting the capsule commodities from the capsule commodity dispensing machine may become cumbersome.

### DISCLOSURE OF THE INVENTION

The present invention is accomplished in view of the problems, and an object of the present invention is to provide a packaged commodity dispensing device in which a package commodity dispensing machine is easily repaired and a packaged commodity is easily supplied and exchanged.

The packaged commodity dispensing device described in claim 1 comprises: a packaged commodity dispensing machine to dispense a packaged commodity; a frame into which the packaged commodity dispensing machine is permitted to detachably fit from forward; and a fixing section to fix the packaged commodity dispensing machine in a state of fitting into the frame.

According to this packaged commodity dispensing device, since the packaged commodity dispersing machine can be attached to or detached from the frame, the packaged commodity dispersing machine can be taken out from the frame irrespective to the other packaged commodity dispersing machines. Thus, when taking out a desired packaged commodity dispersing machine, it is enough to release the fixation of the packaged commodity dispersing machine to the frame irrespective to the other packaged commodity dispersing machines. Also, since the fixing section to fix the packaged commodity dispersing machine in a state of fitting into the frame is provided, the packaged commodity dispersing machine can be fixed to the frame.

In the packaged commodity dispensing device described in claim 2, the packaged commodity dispensing device as claimed in claim 1, wherein frames are permitted to be piled in an upper and lower direction, and a fixing section to fix the frames in a piled state is provided.

According to this capsule commodity dispensing device, since the frames are configured to be piled in the upper and lower direction, a large scale commodity shelf can be structured by piling the frames in the upper and lower direction and fitting the capsule commodity dispersing machines into the frames.

In the packaged commodity dispensing device described in claim 3, the packaged commodity dispensing device as claimed in claim 1 or 2, wherein the frames are permitted to be arranged in parallel in a lateral direction, and a fixing section to fix the frames in a state of being arranged in parallel is provided.

According to this packaged commodity dispensing device, since the frames are configured to be arranged in parallel in the lateral direction, a large scale commodity shelf can be structured by arranging the frames in parallel in the lateral direction and fitting the packaged commodity dispersing machines into the frames.

In the packaged commodity dispensing device described in claim 4, the packaged commodity dispensing device as claimed in claim in any one of claims 1 to 3, wherein a commodity supply opening is formed in an upper surface of a case body of the packaged commodity dispensing machine.

According to this packaged commodity dispensing device, the packaged commodities can be supplied from the commodity supply opening of the case body of the packaged commodity dispersing machine by taking out the packaged commodity dispersing machine from the frame.

In the packaged commodity dispensing device described in claim 5, the packaged commodity dispensing device as claimed in claim 4, wherein a commodity supply opening is formed in an upper surface of the frame from or to which the packaged commodity dispensing machine is permitted to be inserted or removed.

According to this packaged commodity dispensing device, since the commodity supply opening is formed in the upper surface of the frame, the packaged commodities can be supplied from the packaged commodity supply opening without taking out the packaged commodity dispersing machine.

In the packaged commodity dispensing device described in claim 6, the packaged commodity dispensing device as claimed in claim 5, further comprises a commodity storing box which is permitted to directly be fixed to the frame, and a bottom plate of the packaged commodity storing case is permitted to be inserted or removed in a horizontal direction.

According to this packaged commodity dispensing device, since the commodity storing box which can directly be fixed on the frame is provided and the bottom plate of the commodity storing box is configured to be inserted or removed in the horizontal direction, the packaged commodities can easily be supplied by fixing the commodity storing box directly to the frame and removing the bottom plate.

In the packaged commodity dispensing device described in claim 7, the packaged commodity dispensing device as claimed in claim 5, further comprises a commodity display which is permitted to directly be fixed to the frame.

According to this packaged commodity dispensing device, since the commodity display which can directly be fixed on the frame is provided, the packaged commodities can be put in the commodity display to be displayed.

In the packaged commodity dispensing device described in claim 8, the packaged commodity dispensing device as claimed in claim 5, further comprises a commodity storing box which is permitted to detachably fit into the frame from forward.

According to this packaged commodity dispensing device, since the commodity storing box which can detachably fit into the frame from forward is provided, the packaged commodities can easily be supplied by removing the bottom plate.

In the packaged commodity dispensing device described in claim 9, the packaged commodity dispensing device as claimed in claim 5, further comprises a commodity display which is permitted to detachably fit into the frame from forward.

According to this packaged commodity dispensing device, the packaged commodities can be put in the commodity display to be displayed.

In the packaged commodity dispensing device described in claim 10, the packaged commodity dispensing device as claimed in any one of claims 1 to 9, further comprises a base which is permitted to detachably be fixed to a bottom of the frame.

According to this packaged commodity dispensing device, since the base can be fixed to the bottom of the frame, the frame and thus the packaged commodity dispensing machine can be maintained at an appropriate height.

In the packaged commodity dispensing device described in claim 11, the packaged commodity dispensing device as claimed in any one of claims 1 to 10, further comprises a clean box which is permitted to detachably fit into the frame. Further, in the packaged commodity dispensing device described in claim 12, the packaged commodity dispensing device as claimed in any one of claims 1 to 10, the base is provided with a clean box.

According to this packaged commodity dispensing device, since the frame or the base is provided with the clean box, it is not required to separately provide a trash bin or the like.

In the packaged commodity dispensing device described in claim 13, the packaged commodity dispensing device as claimed in any one of claims 1 to 12, wherein at least a front wall of the packaged commodity dispensing machine is formed with a transparent material, and an arch shaped wall portion which protrudes forward is formed at a central portion of the front wall in a width direction.

According to this packaged commodity dispensing device, since the packaged commodities can be filled at the arch shaped wall portion, the packaged commodities can easily be recognized.

In the packaged commodity dispensing device described in claim 14, the packaged commodity dispensing device as claimed in claim 13, wherein protruding pieces are formed inward at both ends of the arch shaped wall portion of the packaged commodity dispensing machine, and a partition plate which removably fits between joint portions of the protruding portions and the arch shaped wall portion is provided.

According to this packaged commodity dispensing device, since the space which is separated from the inside is formed between the partition plate and the arch shaped wall portion, samples or the like can be stored therein.

In the packaged commodity dispensing device described in claim 15, the packaged commodity dispensing device as claimed in claim 14, wherein the partition plate is formed into a shape following an inner surface of the arch shaped wall portion.

According to this packaged commodity dispensing device, when there is no need to provide the space which is separated from the inside, the partition plate can be stored to be close to the arch shaped wall portion.

In the packaged commodity dispensing device described in claim 16, the packaged commodity dispensing device as claimed in claim 15, further comprises a display member which is inserted between the partition plate and the arch shape wall portion.

According to this packaged commodity dispensing device, when the partition plate is stored to be close to the arch shaped wall portion, a display member such as an advertisement or an instruction for use can be displayed therebetween. Also, when the direction of the partition plate is inverted to attach the display member, the packaged commodities are stored in the space formed therebetween, and the display member is moved along the rear surface (protruding side surface) of the partition plate to sandwich and hold the display member between the side edges of the partition plate and the protruding pieces. Thus, both of the commodity samples and the display member can be seen. The display member may be provided to be close to the front side surface of the partition plate, although the holding power would be reduced

In the packaged commodity dispensing device described in claim 17, the packaged commodity dispensing device as claimed in claim 14 or 15, further comprises a shelf at a middle portion in a height direction of the partition plate.

According to this packaged commodity dispensing device, samples or the like can be displayed in a state of placing the samples or the like on the shelf.

In the packaged commodity dispensing device described in claim 18, the packaged commodity dispensing device as claimed in any one of claims 1 to 17, wherein at least the front wall and a side wall of the packaged commodity dispensing machine are formed with a transparent material, and a corner at which the front wall meets the side wall is formed into a curved surface.

According to this packaged commodity dispensing device, even when the packaged commodity dispensing machine is stored in the frame, the packaged commodities inside can be seen.

In the packaged commodity dispensing device described in claim 19, the packaged commodity dispensing device as claimed in any one of claims 1 to 18, wherein an inspection hole is formed in a rear surface of the frame.

According to this packaged commodity dispensing device, residual packaged commodities or the like in the packaged commodity dispensing machine can be checked even from the rear surface side of the frame.

### BRIEF DESCRIPTION OF THE DRAWINGS

The present invention will become more fully understood from the detailed description given hereinafter and the accompanying drawings, however, these are not intended as a definition of the limits of the present invention, and wherein;

FIG. 1 is a perspective view of a capsule commodity dispensing device according to the first embodiment;

FIG. 2 is a perspective view of a capsule commodity dispensing machine in the capsule commodity dispensing device in FIG. 1;

FIG. 3 is a perspective view of the capsule commodity dispensing machine and a frame in the capsule commodity dispensing device in FIG. 1;

FIG. 4 is a perspective view of the frame in the capsule commodity dispensing device in FIG. 1;

FIG. 5 is a view showing a connection structure of the frames in the capsule commodity dispensing device in FIG. 1;

FIG. 6 are perspective views of a base in the capsule commodity dispensing device in FIG. 1, wherein FIGS. 6(A), 6(B) and 6(C) are perspective views of the base each showing a different mode;

FIG. 7 are front views of a commodity storing box in the capsule commodity dispensing device in FIG. 1, wherein FIGS. 7(A) and 7(B) are front views of the commodity storing box each showing a different mode;

FIG. 8 are front views of a commodity display in the capsule commodity dispensing device in FIG. 1, wherein FIGS. 8(A) and 8(B) are front views of the commodity storing box each showing a different mode;

FIG. 9 is a perspective view for explaining a modified example of the capsule commodity dispensing device in FIG. 1;

FIG. 10 is a plan view showing one modified example of the capsule commodity dispensing device in FIG. 1;

FIG. 11 is a plan view showing another modified example of the capsule commodity dispensing device in FIG. 1;

FIG. 12 is a perspective view of a capsule commodity dispensing device according to the second embodiment;

FIG. 13 is a perspective view of a capsule commodity dispensing machine in the capsule commodity dispensing device in FIG. 12;

FIG. 14 are perspective views showing one mode of a display part in the capsule commodity dispensing device in FIG. 12, wherein FIG. 14(A) is a perspective view of a state where a partition plate is not inserted, and FIG. 14(B) is a perspective view of a state where the partition plate is inserted;

FIG. 15 is an expanded perspective view of a main portion of the capsule commodity dispensing device in FIG. 14;

FIG. 16 are perspective views showing another mode of the display part in the capsule commodity dispensing device in FIG. 12, wherein FIG. 16(A) is a perspective view of a state where the partition plate is not inserted, and FIG. 16(B) is a perspective view of a state where the partition plate is inserted;

FIG. 17 is an expanded perspective view of a main portion of the capsule commodity dispensing device in FIG. 16;

FIG. 18 is a perspective view of the capsule commodity dispensing machine and a frame in the capsule commodity dispensing device in FIG. 12;

FIG. 19 is a perspective view of the frame in the capsule commodity dispensing device in FIG. 12;

FIG. 20 is a view showing a connection structure of the frames in the capsule commodity dispensing device in FIG. 12; and

FIG. 21 are perspective views of a base in the capsule commodity dispensing device in FIG. 12, wherein FIGS. 21(A), 21(B) and 21(C) are perspective views of the base each showing a different mode.

### BEST MODE FOR CARRYING OUT THE INVENTION

### First Embodiment

1. Whole Configuration of Capsule Commodity Dispensing Device

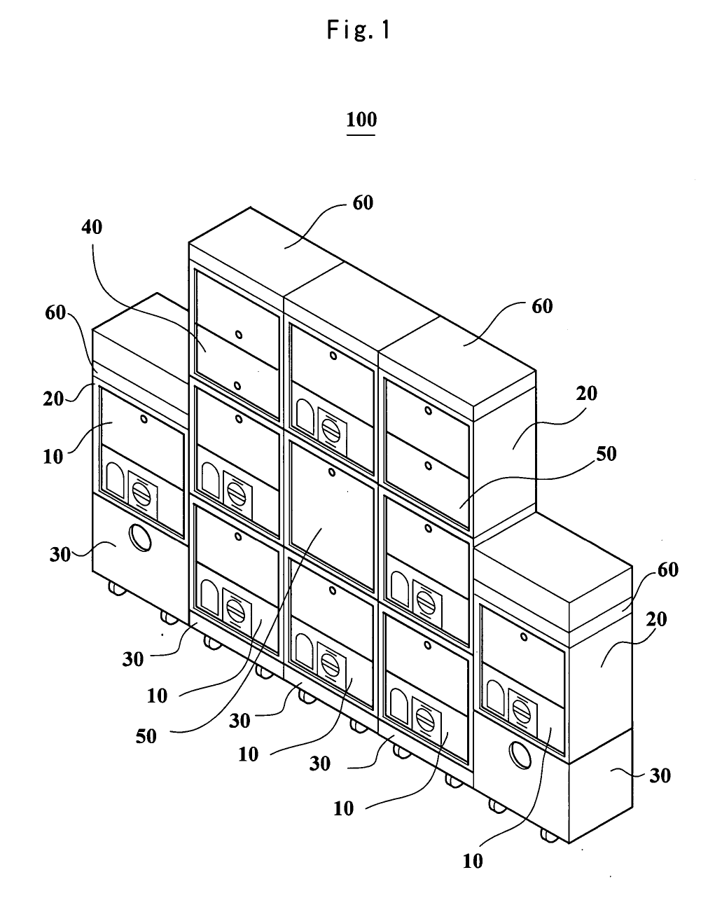

A capsule commodity dispensing device 100 of the embodiment, which is one of the packaged commodity devices, comprises a capsule commodity dispensing machine 10, a frame 20, a base 30, a commodity storing box 40, a commodity display 50 and a cover 60 as shown in FIG. 1.

2. Configuration of Capsule Commodity Dispensing Machine

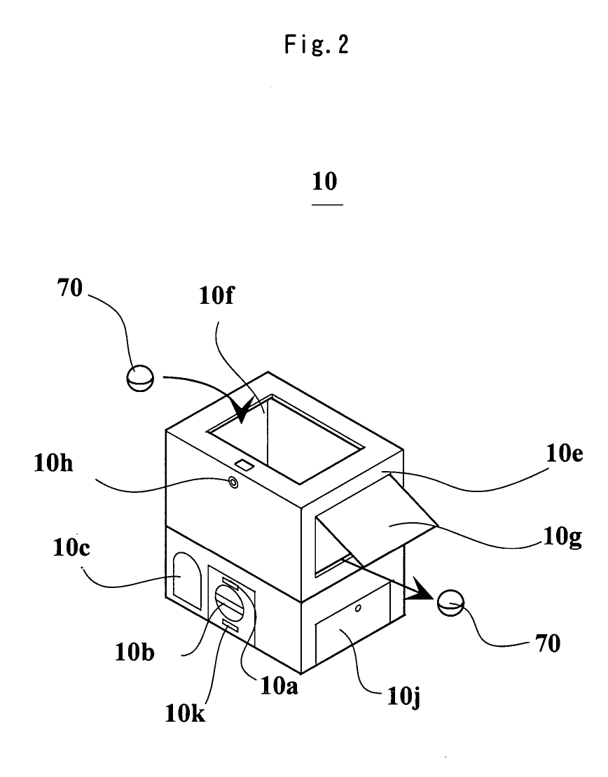

The capsule commodity dispensing machine 10 is formed into a box shape as shown in FIG. 2. However, it is not limited to the box shape. This capsule commodity dispensing machine 10 is configured such that a capsule commodity 70 stored in a case body 10e is dispensed from a commodity dispense opening 10c by turning a handle 10b after inserting a coin into a coin slot 10a on the front surface. Here, a coin is inserted into the coin slot 10c, however, the configuration may be such that a deposit card, a cash card or a credit card is inserted.

In the case body 10e forming the upper structure of the capsule commodity dispensing machine 10, many capsule commodities 70 can be filled in. When the capsule of the capsule commodity 70 is opened, there is a figure or other toy.

The capsule commodity 70 are supplied into the case body 10e from a commodity supply opening 10f provided in the upper surface of the case body 10e. On the other hand, collection of the capsule commodities 70 are performed by opening a door 10g provided on the side surface of the case body 10e.

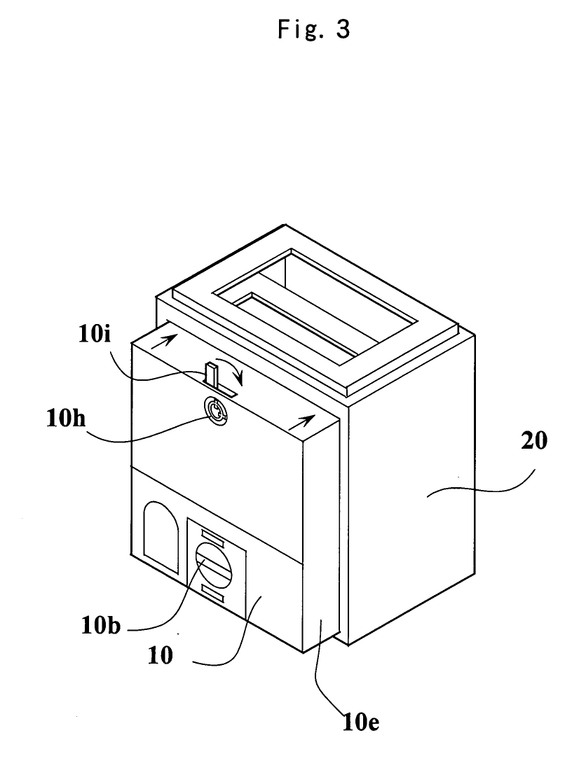

Also, as shown in FIG. 3, a key cylinder 10h is provided on the front surface of the case body 10e. A projecting piece 10i is projected by inserting a key which is not shown into the key cylinder 10h and turning it. When the projecting piece 10i is in a projecting state, it engages with a hole of the frame 20 which is not shown, thereby fixing the capsule commodity dispensing machine 10 to the frame 20.

A mechanical portion forming the lower structure of the capsule commodity dispensing machine 10 is provided with a coin sorting device, a rotation drum which rotates with the rotation of the handle 10b or the like, although they are not shown.

As shown in FIG. 2, the mechanical portion is provided with a cash box 10j on the side portion and a coin return 10k on the front surface.

3. Configuration of Frame 20

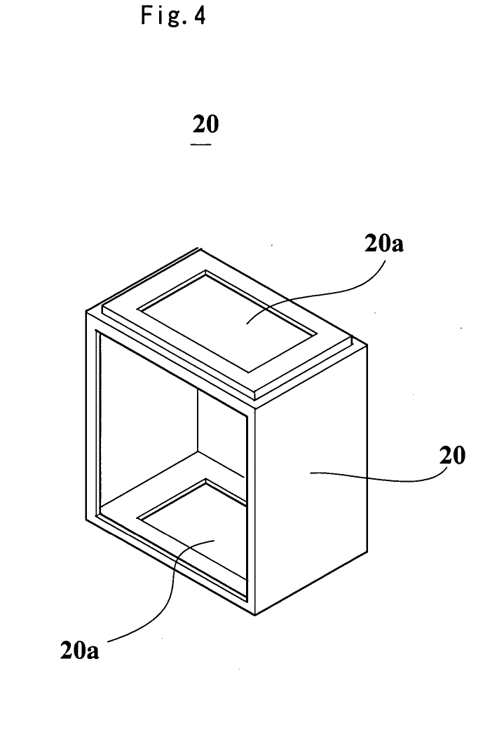

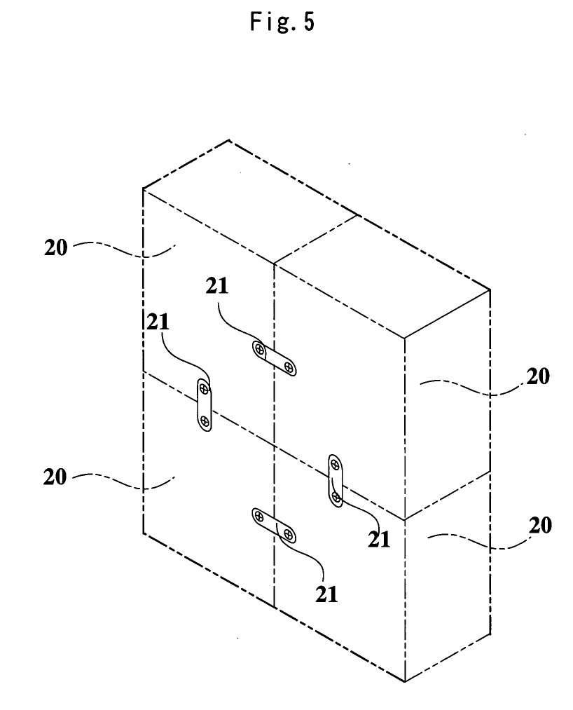

The frame 20 is formed into a box shape, although it is not specifically limited. The capsule commodity dispensing machine 10 can fit into the frame 20 from forward. The frame 20 is configured such that the capsule commodity dispensing machine 10 can be covered excluding the front surface thereof. In the upper surface and the lower surface of the frame 20, as shown in FIG. 4, commodity supply openings 20a are formed to correspond to the commodity supply opening 10f of the capsule commodity dispensing machine 10.

The frames 20 can be piled in the upper and lower direction, and can be arranged in parallel in a lateral direction. Fixation of the adjacent frames is performed by using a connection plate 21 to cross over between the frames 20 on the rear surface side and be screwed shut, although it is not specifically limited thereto.

4. Configuration of Base 30

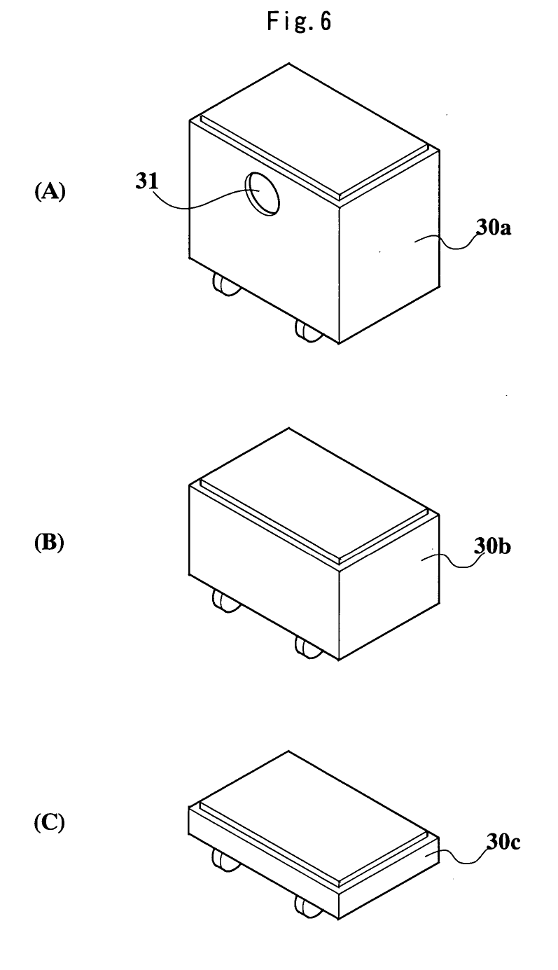

As the base 30 on which the frame 20 is set, three types of bases with a caster are prepared, although it is not specifically limited thereto. The first one is a base 30a with a clean box (FIG. 6(A)), the second one is a standard base 30b (FIG. 6(B)), and the third one is a slim base 30c (FIG. 6(C)). Among them, the base 30a with the clean box is for putting unnecessary capsules, and comprises a capsule slot 31. The capsules which were put in can be taken out from a door which is not shown.

The connection structure of the base 30 and the frame 20 is the same as the connection structure of the frames 20, although it is not limited thereto.

5. Configuration of Commodity Storing Box 40

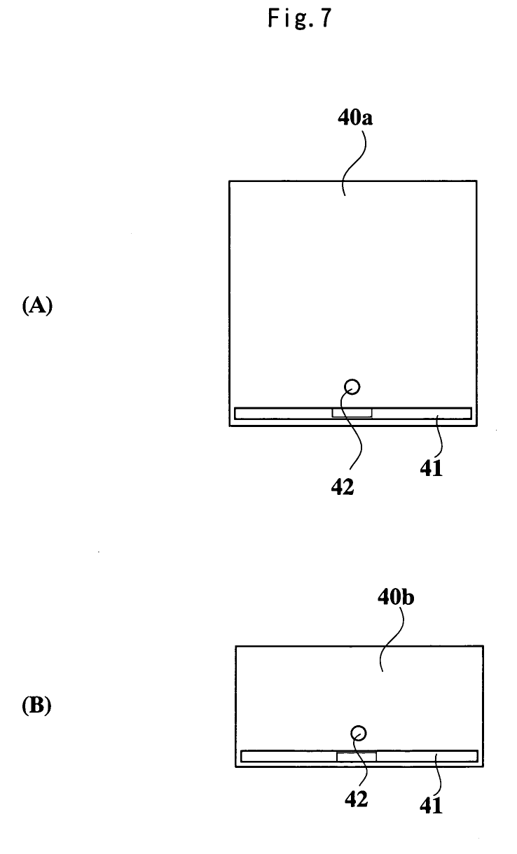

As the commodity storing box 40, two types of commodity storing cases are prepared as shown in FIGS. 7(A) and 7(B), although it is not limited thereto. The first one is a deep commodity storing box 40a, and the second one is a shallow commodity storing box 40b. The commodity storing box 40 can fit into the frame 20 from forward. In this case, only one deep commodity storing box 40a can fit into the frame 20, and two shallow commodity storing boxes can fit into the frame 20 at the upper and lower portions thereof at the same time.

A bottom plate 41 of the commodity storing box 40 can be inserted and removed from forward. Accordingly, when the commodity storing box 40 fits into the frame 20 in a state of storing the capsule commodity into the commodity storing box 40 and the bottom plate 41 is removed, the capsule commodities 60 are supplied into the capsule commodity dispensing machine 10 through the commodity supply openings 10f, 20a.

Further, a key cylinder 42 is provided on the front surface of the commodity storing box 40. A projecting piece which is not shown is projected by inserting a key which is not shown into the key cylinder 42 and turning it. When the projecting piece is in a projecting state, it engages with a hole of the frame 20 which is not shown, thereby fixing the commodity storing box 40 to the frame 20 or the like. It is preferable to provide the key cylinder 42 of the commodity storing box 40 on the lower side of the commodity storing box 40 so that the bottom plate 41 is also fixed by the projecting piece at the same time.

6. Configuration of Commodity Display 50

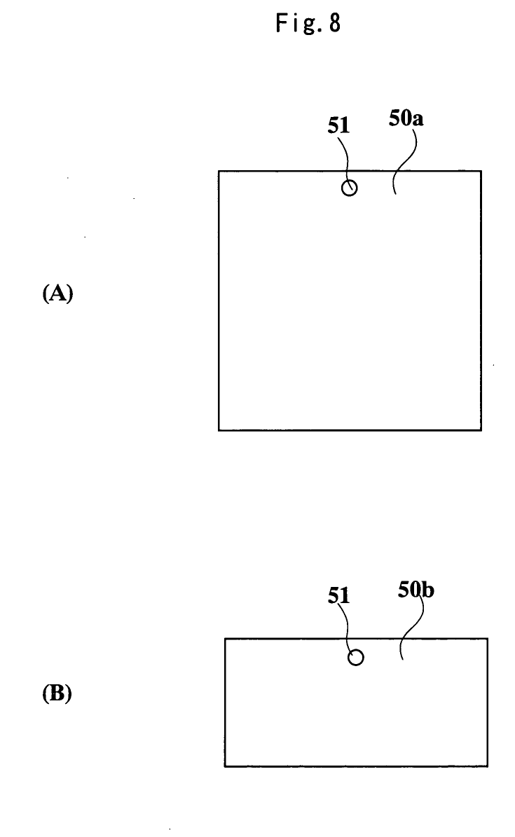

As the commodity display 50, two types of commodity displays are prepared as shown in FIGS. 8(A) and 8(B), although it is not limited thereto. The first one is a shallow commodity display 50a, and the second one is a deep commodity display 50b. The commodity display 50 can fit into the frame 20 from forward.

Also, a key cylinder 51 is provided on the front surface of the commodity display 50. A projecting piece which is not shown is projected by inserting a key which is not shown into the key cylinder 51 and turning it. When the projecting piece is in a projecting state, it engages with a hole of the frame 20 which is not shown, thereby fixing the commodity display 50 to the frame 20 or the like.

7. Configuration of Cover 60

The cover 60 is for covering the commodity supply opening 20a of the frame 20 at the highest stage, and is attached to the frame 20 with a screw or the like.

8. Combination

By arbitrary combining the above capsule commodity dispensing machine 10, the frame 20, the base 30, the commodity storing box 40, the commodity display 50 and the cover 60, the capsule commodity dispensing device 100 is freely configured.

9. Modified Example

The embodiment of the present invention is explained above, however, the present invention is not limited to the embodiment, and it is needless to say that various modifications thereof may be made in a scope of not changing the subject matter of the invention.

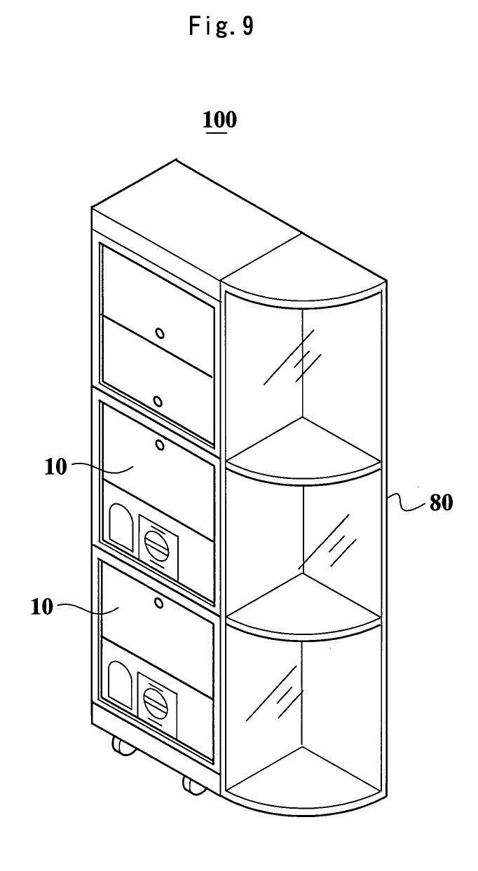

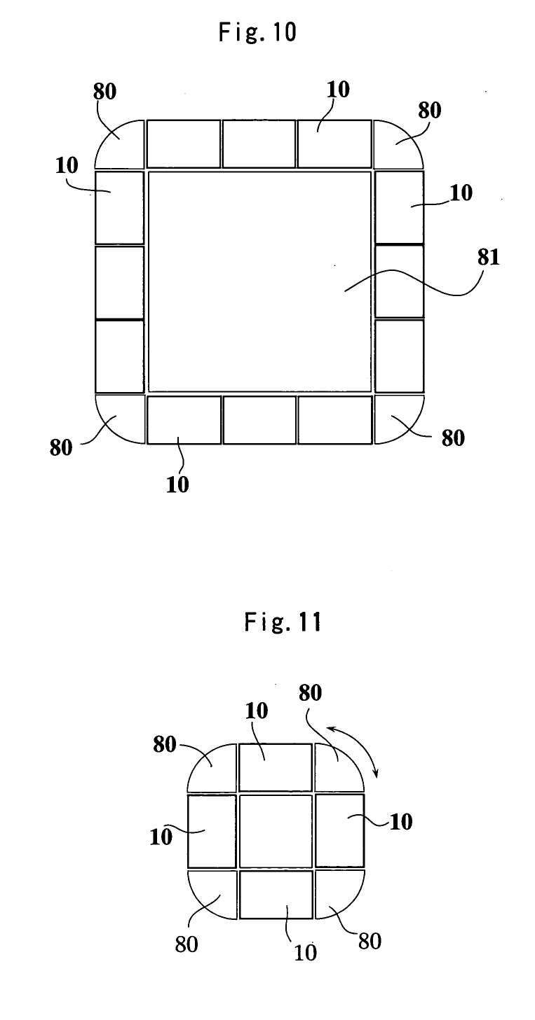

For example, by combining with corner displays 80 shown in FIG. 9, the capsule commodity dispensing machines 10 may be arranged around a column 81 to configure the commodity dispensing device 100 as shown in FIG. 10, or the commodity dispensing device 100 may be configured as shown in FIG. 11 so that the entire commodity dispensing device 100 is placed on the rotating table (not shown) to make the entire commodity dispensing device 100 rotatable.

In the above modification, the clean box is provided on the base, however, the clean box may be provided on the frame.

### Second Embodiment

1. Whole Configuration of Capsule Commodity Dispensing Device

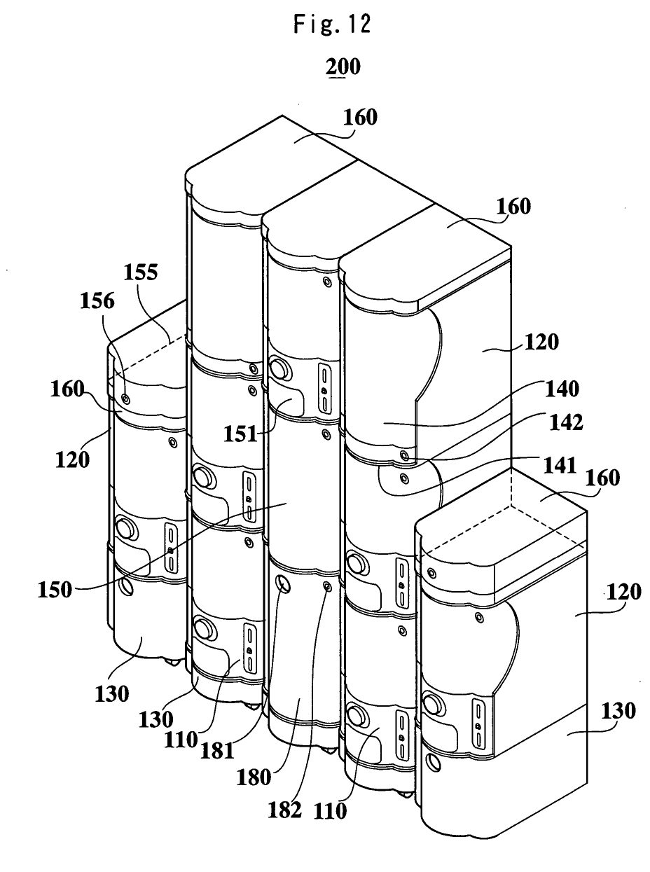

The capsule commodity dispensing device 200 of the embodiment, which is one of the packaged commodity devices, comprises a capsule commodity dispensing machine 110, a frame 120, a base 130, a commodity storing box 140, a commodity display 150 and a cover 160 as shown in FIG. 12.

2. Configuration of Capsule Commodity Dispensing Machine

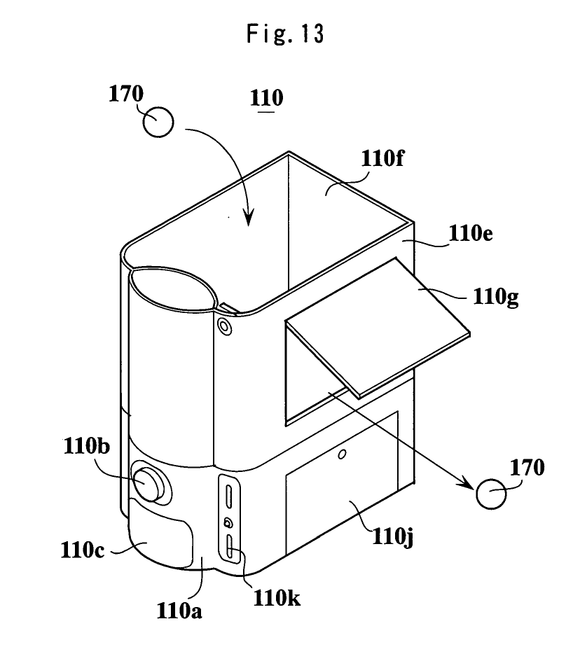

The capsule commodity dispensing machine 110 is formed into a box shape as shown in FIG. 13. However, it is not limited to the box shape. This capsule commodity dispensing machine 110 is configured such that a capsule commodity 170 stored in a case body 110e is dispensed from a commodity dispense opening 110c by turning a handle 110b after inserting a coin into a coin slot 110a on the front surface. Here, a coin is inserted into the coin slot 110c, however, the configuration may be such that a deposit card, a cash card or a credit card is inserted.

In the case body 110e forming the upper structure of the capsule commodity dispensing machine 110, many capsule commodities 170 can be filled in. When the capsule of the capsule commodity 170 is opened, there is a figure or other toy.

The capsule commodities 170 are supplied into the case body 110e from a commodity supply opening 110f provided in the upper surface of the case body 110e. On the other hand, collection of the capsule commodities 170 are performed by opening a door 110g provided on the side surface of the case body 110e.

The case body 110e is formed with a transparent material, corners at which a front wall meets side walls are formed into a curved surface 1101, and a display portion 111 is formed at a center portion of the front wall.

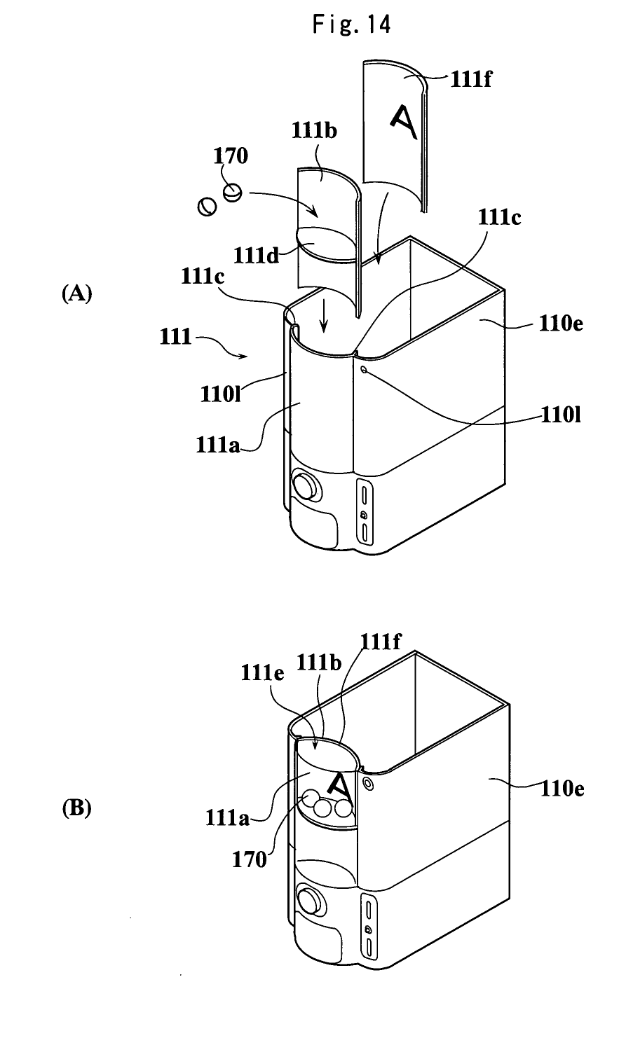

The display portion 111, as shown in FIGS. 14 to 18, comprises an arch shaped wall portion 111a which protrudes forward from the front wall of the case body 110e, and a partition plate 111b. The partition plate 111b is formed into an arch shape with a radius of curvature slightly smaller than that of the arch shaped wall portion 111a. Protruding pieces 111c having a radius of curvature same as that of the arch shaped wall portion 111a are provided inward at both end portions of the arch shaped wall portion 111a. On the other hand, a shelf 111d is disposed at approximately the midpoint in a height direction of the partition plate 111b. The shelf is formed into an approximately elliptical shape, and the outline of a portion projecting from the partition plate 111b is formed into an approximately arch shape having a radius of curvature same as that of the partition plate 111b.

In the display portion 111 configured as above, as shown in FIG. 14(A), the partition plate 111b is fit between the protruding pieces 111c, 111c from upward to project inward of the case body 110e. As shown in FIG. 14(B), the capsule commodities 170 as a sample are stored in a space 111e which is composed of the partition plate 111b, the shelf 111d and the arch shaped wall portion 111a of the case body 110e.

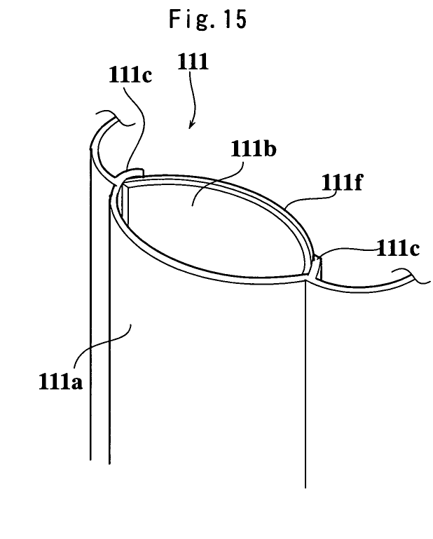

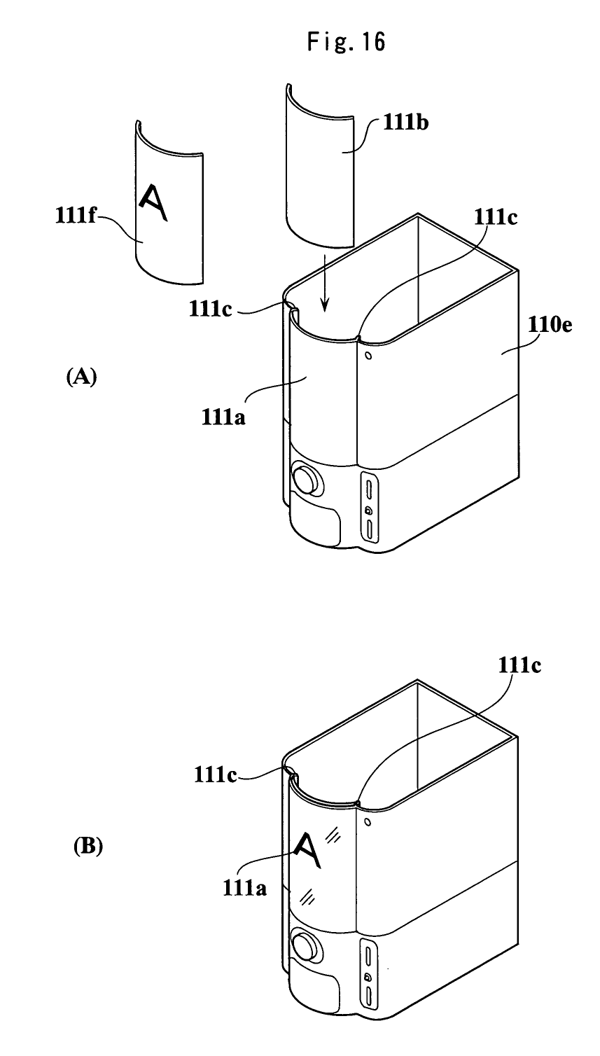

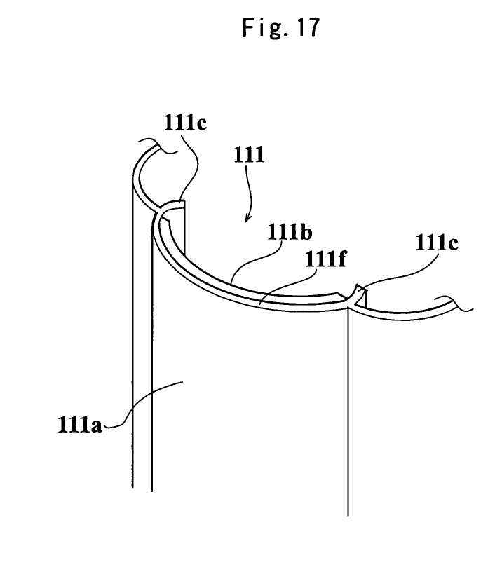

Also, in this display portion 111, by utilizing the space between the arch shaped wall portion 111a or the protruding pieces 111c of the case body 111e and the partition plate 111b, a display member 111f is attached. As one attachment mode, as shown in FIG. 14(A), the display member 111f is moved along the protruding side surface of the partition plate 111b to position the display member 111f inward of the partition plate 111b, so that the display member 111f is fit between the protruding pieces 111c, 111c from upward together with the partition plate 111b. In this case, both side edges of the display member 111f are, as shown in FIG. 15, sandwiched and held by the both side edges of the protruding pieces 111c and the partition plate 111b. As another attachment mode of the display member 111f, as shown in FIG. 16(A), the display member 111f is moved along the protruding side surface of the partition plate 111b to position the display member 111f outward of the partition plate 111b, so that the display member 111f is fit between the protruding pieces 111c, 111c along the inner surface of the arch shaped wall portion 111a from upward together with the partition plate 111b. In this case, as shown in FIG. 17, approximately the entire display member 111f is sandwiched and held by the arch shaped wall portion 111a and the partition plate 111b.

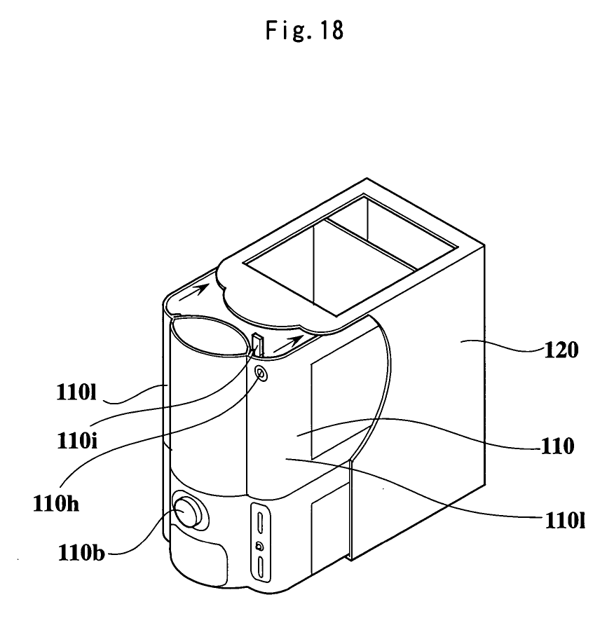

Also, as shown in FIG. 18, a key cylinder 110h is provided on the front surface of the case body 110e. A projecting piece 110i is projected by inserting a key which is not shown into the key cylinder 51 and turning it. When the projecting piece 110i is in a projecting state, it engages with a hole of the frame 120 which is not shown, thereby fixing the capsule commodity dispensing machine 110 to the frame 120.

A mechanical portion forming the lower structure of the capsule commodity dispensing machine 110 is provided with a coin sorting device, a rotation drum which rotates with the rotation of the handle 10b or the like, although they are not shown.

As shown in FIG. 13, the mechanical portion is provided with a cash box 110j on the side portion and a coin return 110k on the front surface.

3. Configuration of Frame 120

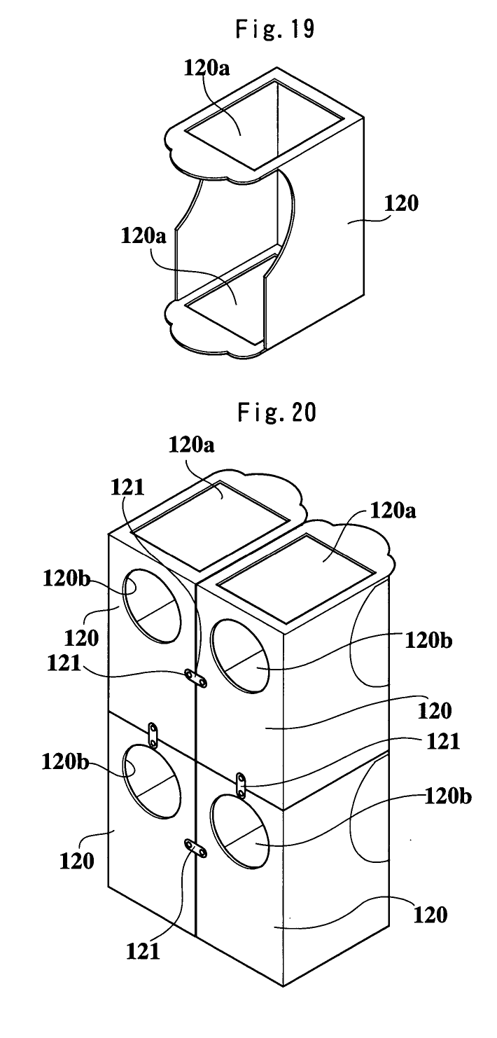

The frame 120 is formed into a box shape, although it is not specifically limited. The capsule commodity dispensing machine 110 can fit into the frame 120 from forward. The frame 120 is configured such that the capsule commodity dispensing machine 110 can be covered excluding the front surface and the corner portions 1101 of the capsule commodity dispensing machine 110. In the upper surface and the lower surface of the frame 120, as shown in FIG. 19, commodity supply openings 120a are formed to correspond to the commodity supply opening 110f of the capsule commodity dispensing machine 110. An inspection hole 120b is formed in the rear surface of the frame 120.

The frames 120 can be piled in the upper and lower direction, and can be arranged in parallel in a lateral direction. Fixation of the adjacent frames is performed by using a connection plate 121 to cross over between the frames 120 on the rear surface side and be screwed shut, although it is not specifically limited thereto.

4. Configuration of Base 130

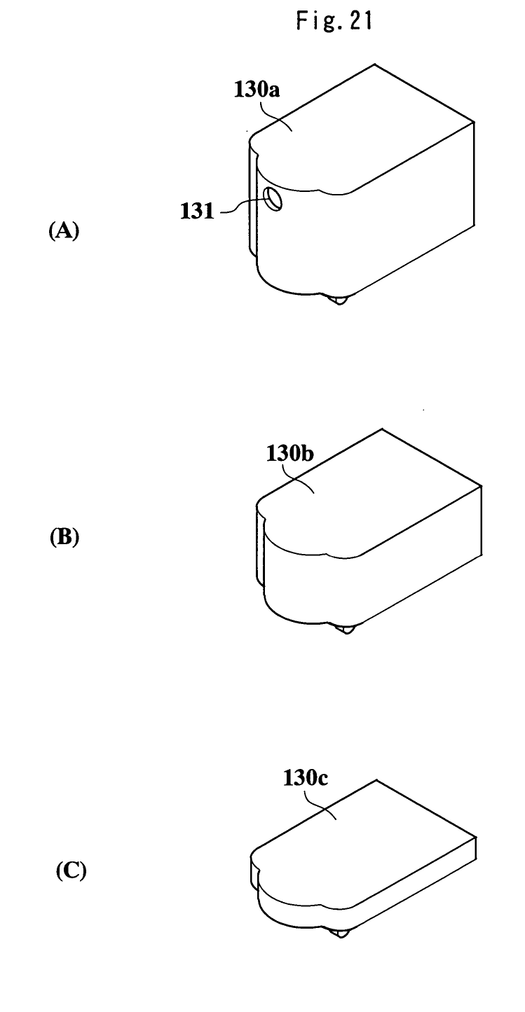

As the base 130 on which the frame 120 is set, three types of bases with a caster are prepared, although it is not specifically limited thereto. The first one is a base 130a with a clean box (FIG. 21(A)), the second one is a standard base 130b (FIG. 21(B)), and the third one is a slim base 130c (FIG. 21(C)). Among them, the base 130a with the clean box is for putting unnecessary capsules, and comprises a capsule slot 131. The capsules which were put in can be taken out from a door which is not shown.

The connection structure of the base 130 and the frame 120 is the same as the connection structure of the frames 120, although it is not specifically limited thereto.

5. Configuration of Commodity Storing Box 140

The commodity storing box 140 can fit into the frame 120 from forward. A bottom plate 141 of the commodity storing box 140 can be inserted and removed from forward. Accordingly, when the commodity storing box 140 is fit into the frame 120 in a state of storing the capsule commodities into the commodity storing box 140 and the bottom plate 141 is removed, the capsule commodities 160 are supplied into the capsule commodity dispensing machine 110 through the commodity supply openings 100f, 120a.

Further, a key cylinder 142 is provided on the front surface of the commodity storing box 140. A projecting piece which is not shown is projected by inserting a key which is not shown into the key cylinder 142 and turning it. When the projecting piece is in a projecting state, it engages with a hole of the frame 120 which is not shown, thereby fixing the commodity storing box 140 to the frame 120 or the like. It is preferable to provide the key cylinder 142 of the commodity storing box 140 on the lower side of the commodity storing box 140 so that the bottom plate 141 is also fixed by the projecting piece at the same time.

6. Configuration of Commodity Display 150 and Small Display 155

The commodity display 150 can fit into the frame 120 from forward. As shown in FIG. 12, a key cylinder 151 is provided on the front surface of the commodity display 150. A projecting piece which is not shown is projected by inserting a key which is not shown into the key cylinder 151 and turning it. When the projecting piece is in a projecting state, it engages with a hole of the frame 120 which is not shown, thereby fixing the commodity display 150 to the frame 120 or the like.

The small display 155 is attachable to the frame 120 or the cover 160 to be described later. In the small display 155, a projecting piece which is not shown is projected by inserting a key which is not shown into a key cylinder 156 and turning it. When the projecting piece is in a projecting state, it engages with a hole of the frame 120 or the cover 160 which is not shown, thereby fixing the small display 150 to the frame 120, the cover 160 or the like.

7. Configuration of Cover 160

The cover 60 is for covering the commodity supply opening 120a of the frame 120 at the highest stage, and is attached to the frame 120 with a screw or the like.

8. Configuration of Clean Box 180

The clean box 18 is for putting unnecessary capsules, and comprises a capsule slot 181. The capsules which were put in can be collected by drawing the clean box 180. This clean box 180 can be replaced with the capsule commodity dispensing machine 110 or the commodity display 150. Here, in the clean box 180, a projecting piece which is not shown is projected by inserting a key which is not shown into the key cylinder 182 and turning it. When the projecting piece is in a projecting state, it engages with a hole of the frame 120 which is not shown, thereby fixing the clean box 180 to the frame 120 or the like.

9. Combination

By arbitrary combining the above capsule commodity dispensing machine 110, the frame 120, the base 130, the commodity storing box 140, the commodity display 150, the small display 155, the cover 160 and the clean box 180, the capsule commodity dispensing device 200 is freely configured.

### INDUSTRIAL APPLICATION

As described above, the packaged commodity dispensing device according to the present invention is effective to provide a point of sale with a large scale at a small space, and is especially suitable for arranging packaged commodity dispensing machines with multiple stages in a height direction.

1. A packaged commodity dispensing device comprising:
a packaged commodity dispensing machine to dispense a packaged commodity;
a frame into which the packaged commodity dispensing machine is permitted to detachably fit from forward; and
a fixing section to fix the packaged commodity dispensing machine in a state of fitting into the frame.

2. The packaged commodity dispensing device as claimed in claim 1, wherein the frame is a plurality of frames are permitted to be piled in an upper and lower direction, and the fixing section fixes the frames in a piled state is provided.

3. The packaged commodity dispensing device as claimed in claim 1, wherein the frame is a plurality of frames permitted to be arranged in parallel in a lateral direction, andthe fixing section fixes the frames in a state of being arranged in parallel is provided.

4. The packaged commodity dispensing device as claimed in claim 1, wherein a commodity supply opening is formed in an upper surface of a case body of the packaged commodity dispensing machine.

5. The packaged commodity dispensing device as claimed in claim 4, wherein a commodity supply opening is formed in an upper surface of the frame from or to which the packaged commodity dispensing machine is permitted to be inserted or removed.

6. The packaged commodity dispensing device as claimed in claim 5, further comprising a commodity storing box which is permitted to directly be fixed to the frame, and a bottom plate of the packaged commodity storing case is permitted to be inserted or removed in a horizontal direction.

7. The packaged commodity dispensing device as claimed in claim 5, further comprising a commodity display which is permitted to directly be fixed to the frame.

8. The packaged commodity dispensing device as claimed in claim 5, further comprising a commodity storing box which is permitted to detachably fit into the frame from forward.

9. The packaged commodity dispensing device as claimed in claim 5, further comprising a commodity display which is permitted to detachably fit into the frame from forward.

10. The packaged commodity dispensing device as claimed in claim 1, further comprising a base which is permitted to detachably be fixed to a bottom of the frame.

11. The packaged commodity dispensing device as claimed in claim 1, further comprising a clean box which is permitted to detachably fit into the frame.

12. The packaged commodity dispensing device as claimed in claim 1, the base is provided with a clean box.

13. The packaged commodity dispensing device as claimed in claim 1, wherein at least a front wall of the packaged commodity dispensing machine is formed with a transparent material, and an arch shaped wall portion which protrudes forward is formed at a central portion of the front wall in a width direction.

14. The packaged commodity dispensing device as claimed in claim 13, wherein protruding pieces are formed inward at both ends of the arch shaped wall portion of the packaged commodity dispensing machine, and a partition plate which removably fits between joint portions of the protruding portions and the arch shaped wall portion is provided.

15. The packaged commodity dispensing device as claimed in claim 14, wherein the partition plate is formed into a shape following an inner surface of the arch shaped wall portion.

16. The packaged commodity dispensing device as claimed in claim 15, further comprising a display member which is inserted between the partition plate and the arch shape wall portion.

17. The packaged commodity dispensing device as claimed in claim 14, further comprising a shelf at a middle portion in a height direction of the partition plate.

18. The packaged commodity dispensing device as claimed in claim 1, wherein at least a front wall and a side wall of the packaged commodity dispensing machine are formed with a transparent material, and a corner at which the front wall meets the side wall is formed into a curved surface.

19. The packaged commodity dispensing device as claimed in claim 1, wherein an inspection hole is formed in a rear surface of the frame.
